(19) United States
(12) Patent Application Publication
(10) Pub. No.: US 2016/0205863 A1
(43) Pub. Date: Jul. 21, 2016

(54) WINDROWER TRACTOR CONTROLLED BY FORWARD-NEUTRAL-REVERSE GROUND SPEED LEVER

(71) Applicant: AGCO CORPORATION, Hesston, KS (US)

(72) Inventors: Brendon Nafziger, Canton, KS (US); Daniel James Soldan, Hillsboro, KS (US)

(21) Appl. No.: 14/914,454

(22) PCT Filed: Sep. 15, 2014
(86) PCT No.: PCT/US2014/055557

§ 371 Date: Feb. 25, 2016

Related U.S. Application Data
(60) Provisional application No. 61/877,742, filed on Sep. 13, 2013.

(51) Int. Cl. A01B 76/00; F16H 59/04; B60K 26/02; F16H 59/06; B60K 31/00

(52) U.S. Cl. CPC A01B 76/00; F16H 59/06; B60K 31/00; B60K 26/02; F16H 59/044; B60K 2026/029; B60K 2031/0091; B60K 2310/20; B60K 2310/244

(57) ABSTRACT

A speed and direction controller for selectively providing infinitely variable and incremental control of groundspeed of an agricultural vehicle. The speed and direction controller may communicate with a control system for controlling groundspeed of the agricultural vehicle. The speed and direction controller may include a forward-neutral-reverse (FNR) lever and incremental control elements located on the FNR lever. The FNR lever may be infinitely variable between a maximum forward position and a maximum rearward position, corresponding with a maximum forward groundspeed and a maximum rearward groundspeed, respectively. The incremental control elements may be manipulated by a user to send a signal to the control system for increasing or decreasing the maximum forward or rearward groundspeed by a predetermined amount. This increase or decrease in the maximum forward or rearward groundspeeds may be used by the control system to scale speed commands received from the FNR lever.

### CROSS REFERENCE TO RELATED APPLICATION

This application claims the benefit of U.S. Provisional Application No. 61/877,742, entitled WINDROWER TRACTOR CONTROLLED BY FORWARD-NEUTRAL-REVERSE GROUND SPEED LEVER, filed Sep. 13, 2013, which is hereby incorporated by reference in its entirety.

### BACKGROUND OF THE INVENTION

1. Field of Invention

This invention relates to control of ground speed on agricultural vehicles, and more particularly to a forward-neutral-reverse lever with incremental control elements located on the lever.

2. Description of Related Art

Some hydrostatic-propelled vehicles, such as self-propelled windrower tractors, use a forward-neutral-reverse (FNR) lever to control vehicle ground speed. The speed and direction of the vehicle is proportional to the relative position of the FNR lever in a console slot of the vehicle. It can be difficult for an operator to make precise speed adjustments by moving the FNR lever by small amounts when operating in rough terrain.

### OVERVIEW OF THE INVENTION

In one embodiment, the invention is directed to a speed and direction controller for an agricultural vehicle that selectively allows for both infinitely variable and incremental control of groundspeed. The agricultural vehicle may include a control system communicably coupled with the speed and direction controller and a vehicle actuation system configured to receive command signals from the control system. The vehicle actuation system may control groundspeed of the agricultural vehicle.

The speed and direction controller may include both a forward-neutral-reverse (FNR) lever and incremental control elements located on the FNR lever. The FNR lever may be infinitely variable between a maximum forward position, a neutral position, and a maximum rearward position. Specifically, the FNR lever may send a signal to the control system to actuate the agricultural vehicle at a maximum forward groundspeed when the FNR lever is at the maximum forward position and to actuate the agricultural vehicle at a maximum rearward groundspeed when the FNR lever is at the maximum rearward position. When the FNR lever is at a position between the neutral position and one of the maximum positions, the groundspeed is proportional to a position of the FNR lever. For example, if the FNR lever is three-quarters of the way between the neutral position and the maximum forward position, and the maximum forward groundspeed is 10 miles per hour (mph), then the current groundspeed of the agricultural vehicle would be approx. 7.5 miles per hour (i.e., 75% of 10). The control system may receive signals from the FNR lever corresponding to a direction (i.e., forward or reverse) and a speed (or a proportion of maximum speed) at which the agricultural vehicle should travel.

The incremental control elements may include an upshift button and a downshift button for sending control signals to the control system when pressed by an operator. Manipulation of the incremental controls may scale the speed commands from the FNR lever by a predetermined increment. Specifically, the control system may be configured to scale the speed commands from the FNR lever by the predetermined increment based on operator manipulation of the incremental control elements. For example, the control system may scale the vehicle speed command signals output to the vehicle actuation system by adding or subtracting the predetermined increment to the maximum forward or maximum rearward groundspeed to calculate a new maximum forward or maximum rearward groundspeed. Then the control system may multiply the new maximum forward or maximum rearward groundspeed by the ratio corresponding to the position of the FNR lever between the neutral position and the maximum forward or maximum rearward position (e.g., half-way between neutral and the maximum forward position). Specifically, the control system may add the predetermined increment to the maximum forward or maximum rearward groundspeed if the upshift button is pressed and subtract the predetermined increment from the maximum forward or maximum rearward groundspeed if the downshift button is pressed.

For example, if the maximum forward groundspeed is 10 mph and the upshift button is pressed once, an increment of 0.5 mph may be added thereto, such that the maximum forward groundspeed is now 10.5 mph. If the FNR lever was half way between the neutral position and the maximum forward position, then the groundspeed increases from 5 mph to 5.25 mph. On the other hand, if the downshift button is pressed, the maximum forward groundspeed may be decreased from 10 mph to 9.5 mph and if the FNR lever was half way between the neutral position and the maximum forward position, then the groundspeed decreases from 5 mph to 4.75 mph. Or, if the upshift button was pressed twice, then the groundspeed increases from 5 mph to 5.5 mph.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of an agricultural vehicle including a speed and direction controller constructed in accordance with an embodiment of the present invention;

FIG. 2 is a perspective view of the speed and direction controller of FIG. 1, including a forward-neutral-reverse (FNR) lever and incremental control elements;

FIG. 3 is a perspective view of the FNR lever of FIG. 2 actuated to a maximum forward position in a console slot of the agricultural vehicle of FIG. 1;

FIG. 4 is a perspective view of the FNR lever of FIG. 3, actuated to a maximum rearward position in the console slot;

FIG. 5 is a perspective view of the FNR lever of FIG. 3, actuated to a neutral position in the console slot; and

FIG. 6 is a block diagram illustrating communication between the speed and direction controller, a control system and a vehicle actuation system of the agricultural vehicle of FIG. 1.

The drawing figures do not limit the present invention to the specific embodiments disclosed and described herein. The drawings are not necessarily to scale, emphasis instead being placed upon clearly illustrating the principles of the invention. Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

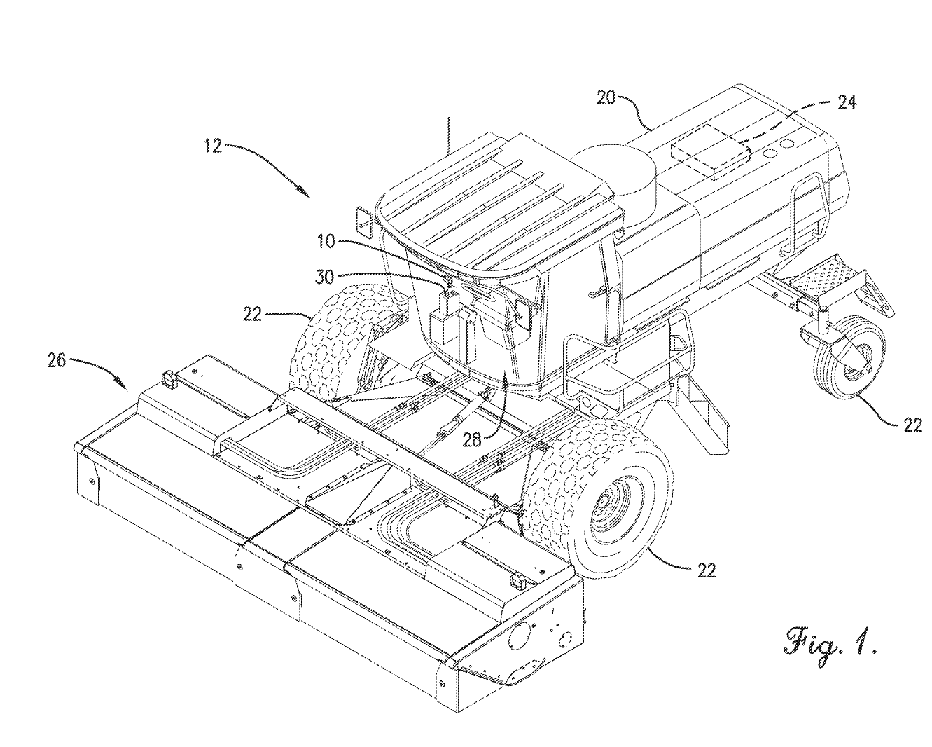

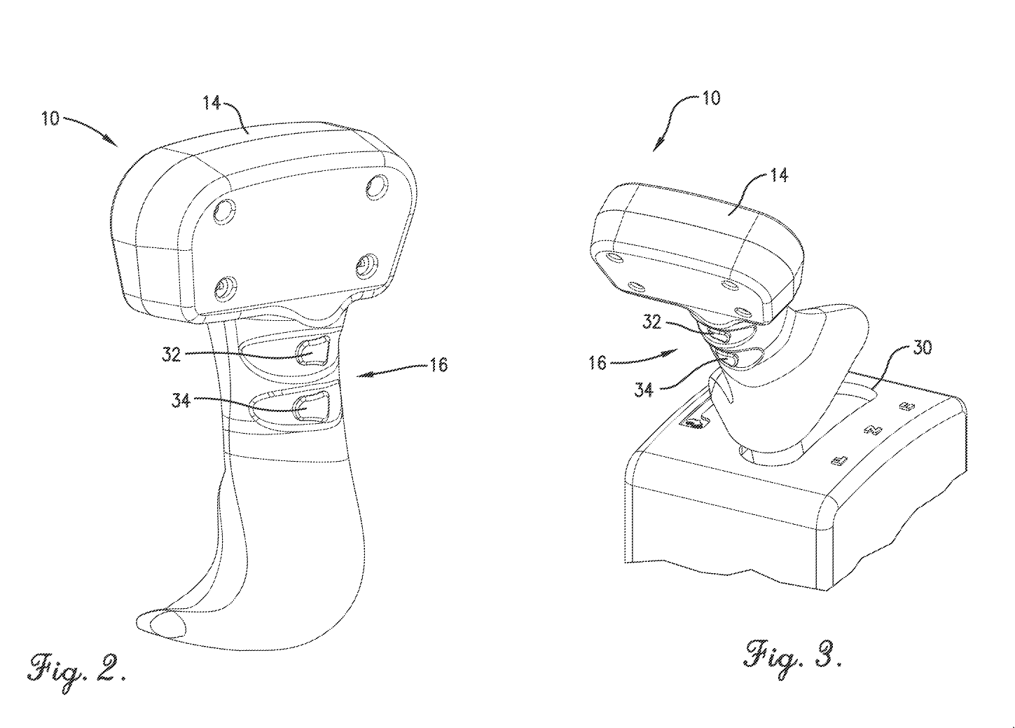

As illustrated in FIGS. 1-6, the present invention is a speed and direction controller 10 for an agricultural vehicle 12 configured to provide both infinitely variable control and incremental control of groundspeed. As illustrated in FIGS. 2-6, the speed and direction controller 10 comprises a forward-neutral-reverse (FNR) lever 14 and incremental control elements 16 located on the FNR lever 14. The speed and direction controller 10 may further comprise and/or be communicably coupled to a control system 18 of the agricultural vehicle 12. The FNR lever 14 and the incremental control elements 16 may be configured to send control signals to the control system 18 when physically manipulated by an operator of the agricultural vehicle 12. In response to these control signals, the control system 18 may command the agricultural vehicle 12 to increase and/or decrease groundspeed of the agricultural vehicle 12 forward or rearward in an infinitely-variable or incremental manner.

As illustrated in FIG. 1, the agricultural vehicle 12 may any vehicle used in the agricultural industry, such as a hydrostatic propelled windrower tractor. The agricultural vehicle 12 may comprise a frame 20, wheels 22, and a vehicle actuation system 24, as well as the control system 18 mentioned above. The frame 20 may support various agricultural implements 26, such as a header, sickle header, seeder, baler, or any agricultural implement known in the art. The frame 20 may also have a cab portion 28 in which the operator may sit and access the speed and direction controller 10 and/or other elements communicably coupled with the control system 18. The frame 20 may be transported on and rotatably attached to the wheels 22, and the wheels 22 may be actuated by the vehicle actuation system 24. The vehicle actuation system 24 may comprise any agricultural vehicle actuation system known in the art, such as a motor and/or hydrostatic actuation system mechanically coupled with the wheels 22. The vehicle actuation system 24 may receive commands from the control system 18 and/or the FNR lever 14 for increasing and/or decreasing the rotational speed of the wheels 22 and thus increasing and/or decreasing the groundspeed of the agricultural vehicle 12.

In some embodiments of the invention, the vehicle actuation system 24 may comprise fully variable wheel motor swashplates and hydrostatic pumps. The positions of the swashplates may be determined by the control system 18 based on groundspeed and, at times, by range selections, as described below. In some embodiments of the invention, at speeds up to approximately 10 miles per hour (mph), the swashplates may be in a maximum displacement position and vehicle speed changes may be accomplished solely by varying displacement of the hydrostatic pumps. At speeds above approximately 10 miles per hour, the pump and motor swashplates may move simultaneously. That is, to speed up, the motor swashplates simultaneously decrease in displacement while the pumps increase in displacement. The vehicle actuation system 24 may function in this manner regardless of whether the agricultural vehicle's groundspeed is changed by moving the FNR lever 14 or by manipulating the incremental control elements 16 described below.

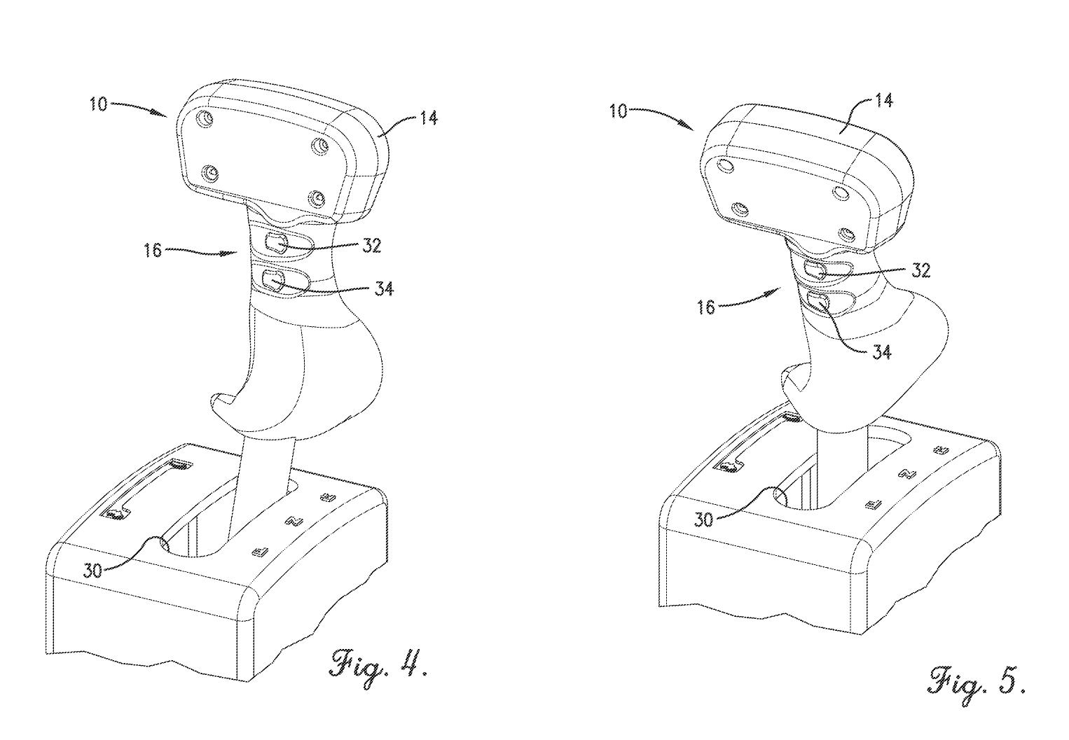

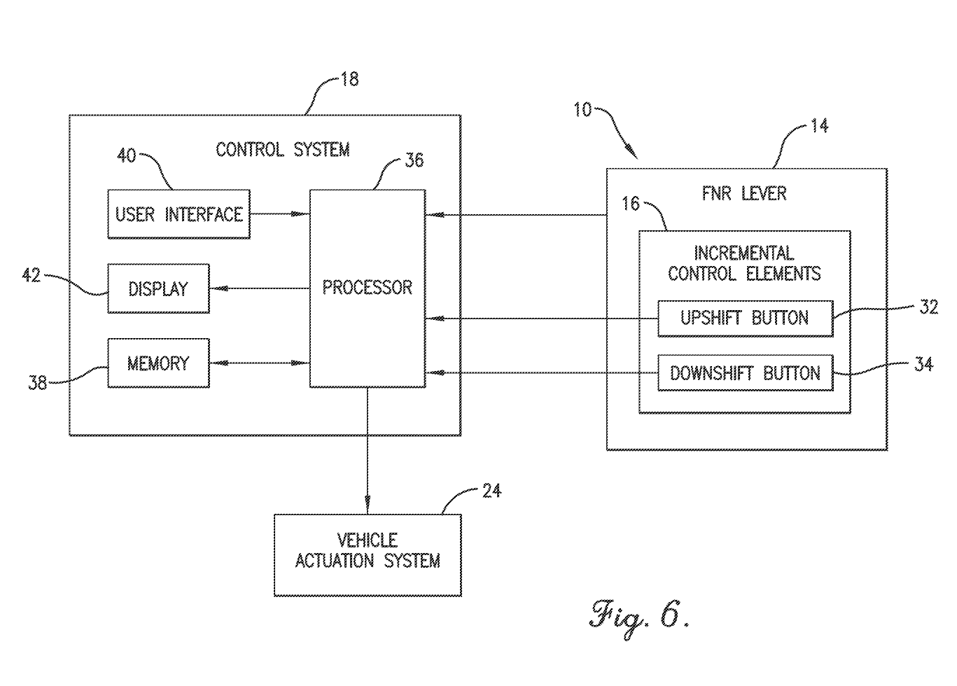

The FNR lever 14 may be a standard FNR lever used in agricultural vehicles and may be communicably coupled with the control system 18 and/or the vehicle actuation system 24. Specifically, the FNR lever may have a standard lever or joy stick configuration and may be actuatable to pivot or slide forward and backwards. For example, the FNR lever 14 may be slidable or pivotable within a console slot 30 of the agricultural vehicle 10, as illustrated in FIGS. 1 and 3-5. The console slot 30 may limit how far forward and how far backward the FNR lever 14 may be actuated. The FNR lever 14 may have a maximum forward position (as illustrated in FIG. 3), a maximum rearward position (as illustrated in FIG. 4), and a designated neutral position (as illustrated in FIG. 5) somewhere between the maximum forward position and the maximum rearward position. When the FNR lever 14 is in the neutral position, the actuation system of the agricultural vehicle 12 does not drive the wheels 22 to rotate forward or backwards. As the FNR lever 14 is pushed forward from the neutral position, the vehicle actuation system 24 gradually increases a forward rotational speed of the wheels 22. As the FNR lever 14 is pulled rearward from the neutral position, the vehicle actuation system 24 gradually increases a rearward rotational speed of the wheels 22. As the FNR lever 14 is pushed forward from the maximum rearward position toward the neutral position, the vehicle actuation system 24 gradually decreases the rearward rotational speed of the wheels 22. Likewise, as the FNR lever 14 is pulled rearward from the maximum rearward position toward the neutral position the vehicle actuation system 24 gradually decreases the forward rotational speed of the wheels 22. Alternatively, the maximum forward position of the FNR lever 14 may correspond with rearward rotation of the wheels 22 and the maximum rearward position of the FNR lever 14 may correspond with forward rotation of the wheels 22.

The FNR lever 14 may be infinitely variable or non-incrementally variable and may therefore be actuated or shifted to any point between the neutral position and one of the maximum positions. In these positions between the maximum positions and the neutral position, the resulting groundspeed may be determined based on a ratio of the maximum forward or maximum rearward groundspeed. For example, if the FNR lever 14 is three-quarters of the way between the neutral position and the maximum forward position, and the maximum forward groundspeed is 10 mph, then the current groundspeed of the agricultural vehicle 12 would be 7.5 mph (i.e., 75% of 10). Likewise, if the FNR lever 14 is half way between the neutral position and the maximum forward position, the current groundspeed of the agricultural vehicle 12 would be 5 mph.

The incremental control elements 16 may include buttons, switches, or other known incremental control elements. For example, the incremental control elements 16 may include at least one upshift button 32 and at least one downshift button 34 located on the FNR lever 14 to increase and decrease or scale the groundspeed of the agricultural vehicle 12 by pre-determined increments. This allows the speed of the agricultural vehicle 12 to be varied without moving the FNR lever 14, which allows for increased control and more precise speed adjustments of the agricultural vehicle 12, especially in rough field conditions. Specifically, the upshift button 32 and the downshift button 34 may be located directly on the FNR lever 14 and may be pressed and released to “upshift” or “downshift” the speed of the agricultural vehicle 12 by one predefined increment or predefined amount. If pressed and released multiple times, the upshift and downshift buttons 32, 34 may increase, decrease, or rescale speed signals output by the control system 18 multiple times by multiples of the predefined increments.

The incremental control elements 16, such as the upshift and downshift buttons 32, 34, may be located anywhere on the FNR lever 14. As illustrated in FIGS. 1-5, the upshift and downshift buttons 32, 34 may be located on a front side of the FNR lever 14 facing away from the operator sitting in the agricultural vehicle 12, such that when the operator grips the FNR lever 14, the operator's pointer finger, middle finger, ring finger, and/or pinky finger may be positioned to reach and press the buttons 32, 34. Alternatively, the upshift and downshift buttons 32, 34 may be located on a top or rear side of the FNR lever 14 such that the operator's thumb may easily reach and press the buttons 32, 34.

The incremental control elements 16 are communicably coupled with the control system 18, which is configured to re-scale the FNR lever 14 to provide a different forward and rearward maximum speed when the FNR lever 14 is at the maximum forward position and/or the maximum rearward position. The speed of the agricultural vehicle 12 is thus adjusted in proportion to the FNR lever's current position relative to the maximum forward position, the neutral position, and the maximum rearward position. The incremental control elements 16 allow an operator of the agricultural vehicle 12 to select the most appropriate method of speed control for current conditions—adjusting the FNR lever 14, pushing one of the upshift or downshift buttons 32, 34, or some combination thereof. This also provides a convenient way to set a maximum vehicle speed, for example when running a sickle header where there is a limit on a maximum groundspeed at which the sickle header can be operated.

The control system 18 is configured to receive control signals from the FNR lever 14 and the incremental control elements 16 and, in response, send commands to the vehicle actuation system 24 to increase or decrease speed in a forward or rearward direction. In some embodiments of the invention, the control system 18 may be a computerized ground speed control system, such as a standard windrower ground speed control system comprising a processor 36, memory 38, a user interface 40, and a display 42.

The processor 36 may comprise any number and type of computer processors, servers, controllers, integrated circuits, programmable logic devices, or other computing devices and resident or external memory for storing data, executable code segments, images, and other information accessed and/or generated by the processor 36. The processor 36 may have a computer program, algorithms, and/or code segments stored thereon or accessible thereby for performing the method steps and other functions described herein. The computer program preferably comprises an ordered listing of executable instructions for implementing logical functions in the processor 36. The computer program can be embodied in any computer-readable medium for use by or in connection with an instruction execution system, apparatus, or device, and execute the instructions. In the context of this application, a “computer-readable medium” can be any system and/or device that can contain, store, communicate, propagate, or transport the program for use by or in connection with an instruction execution system, apparatus, or device. The computer-readable medium can be, for example, but not limited to, an electronic, magnetic, optical, electromagnetic, infrared, or semi-conductor system, apparatus or device. More specific, although not inclusive, examples of the computer-readable medium would include the following: an electrical connection having one or more wires, data storage devices such as hard disc drives or solid-state drives, a portable computer diskette, a random access memory (RAM), a read-only memory (ROM), an erasable, programmable, read-only memory (EPROM or Flash memory), an optical fiber, and a portable compact disc read-only memory (CDROM).

The memory 38 may include, for example, removable and non-removable memory elements such as RAM, ROM, flash, magnetic, optical, USB memory devices, and/or other conventional memory elements. The memory 38 may store various data associated with the agricultural vehicle, such as the computer program and code segments mentioned above, or other data for instructing the control system to perform the steps described herein. Further, the memory may store data input by the operator via the user interface 40, FNR lever 14, and/or the incremental control elements 16. In some embodiments of the invention, the memory 40 may store therein speed increments by which to upshift or downshift groundspeed commands when the incremental control elements 16 are manipulated. For example, in some embodiments of the invention, there may be nineteen speed settings available in half mile-per-hour increments. These increments may be preset by a manufacturer or alternatively written into the memory 38 by an operator's selection via the user interface 40. The various data stored within the memory 38 may also be associated within one or more databases to facilitate retrieval of the information.

The user interface 40 may permit a user to operate the agricultural vehicle 12 and enables users, third parties, or other devices to share information with the agricultural vehicle 12. The user interface 40 may comprise one or more functionable inputs such as buttons, switches, scroll wheels, a touch screen associated with the display, voice recognition elements such as a microphone, pointing devices such as mice, touchpads, tracking balls, styluses, a camera such as a digital or film still or video camera, combinations thereof, etc. Further, the user interface 40 may comprise wired or wireless data transfer elements such as removable memory, data transceivers, etc., to enable the user and other devices or parties to remotely interface with the agricultural vehicle 12. The user interface 40 may also include a speaker for providing audible instructions and feedback. In some embodiments of the invention, the FNR lever 14 and/or the incremental control elements 16 may be considered part of the user interface 40.

The display 42 may comprise a graphical interface operable to display visual graphics, images, text, etc. in response to external or internal processes and commands. For example, the display 42 may comprise conventional black and white, monochrome, or color display elements including CRT, TFT, LCD, and/or LED display devices. The display 42 may be integrated with the user interface 40, such as in embodiments where the display 42 is a touch screen display to enable the user to interact with it by touching or pointing at display areas to provide information or selections to the processor 36. The display 42 may be communicably coupled with the processor 36 and may be operable to display various information corresponding to the groundspeed and/or direction of the agricultural vehicle 12, a current maximum groundspeed of the agricultural vehicle 12 depending on a most-recent manipulation of the incremental control elements 16, available speed increments for upshifting and downshifting via the incremental control elements 16, header speeds, etc.

In use, an operator of the agricultural vehicle 12 may start the motor of the vehicle actuation system 24 with the FNR lever 14 in the neutral position, as in FIG. 5. The operator may actuate the FNR lever 14 forward or backward, depending on a desired direction of travel, by a given amount, depending on a desired groundspeed for the agricultural vehicle 12. The operator may continue to control groundspeed and direction of travel via the FNR lever 14. Furthermore, the operator may additionally or alternatively change the groundspeed by a precise amount instantaneously or nearly instantaneously by manipulating one of the incremental control elements 16. For example, the operator may push the upshift button 32 to increase the speed of the agricultural vehicle 12 or may push the downshift button 34 to decrease the speed of the agricultural vehicle 12.

When the FNR lever 14 is manipulated, pivoted, or slid within the console slot 30, the FNR lever 14 may send a corresponding signal to the control system 18. The control system 18 or the processor 36 thereof may then send a signal to the vehicle actuation system 24 to appropriately adjust the speed of the agricultural vehicle 12 in an analog, continuous, or infinitely variable manner. When the incremental control elements 16 or upshift and downshift buttons 32, 34 are manipulated by the operator, a signal is sent thereby to the control system 18, which then sends a signal to the vehicle actuation system 24 to appropriately adjust the speed of the agricultural vehicle 12 by scaling the speed commands of the FNR lever 14 by predefined increments, as described below.

The upshift and downshift commands via the incremental control elements 16 do not necessarily make any physical changes to the vehicle actuation system 24, such as changing swashplate angles and the like. Rather, the upshift and downshift buttons 32,34 correspond with command signals and/or code segments executed by the control system 18 for rescaling the maximum speeds associated with the maximum positions of the FNR lever 14, thus changing the amount by which the groundspeed can change when the FNR lever 14 is moved by a particular amount forwards or rearward. In other words, the incremental control elements 16 may provide a virtual gear shift, which may be indicated on the display 42, but not a physical gear shift of any of the elements of the vehicle actuation system 24.

Specifically, the control system 18 or the processor 36 thereof is configured to set and/or reset a maximum forward groundspeed and a maximum rearward groundspeed each time the incremental control elements 16 are manipulated or the upshift or downshift buttons 32, 34 are pressed. For example, if the FNR lever 14 is positioned half way between the maximum forward position and the neutral position, and the maximum forward groundspeed is set at 4 mph, then the agricultural vehicle 12 would be traveling at 2 mph. If the FNR lever 14 is not moved, but the upshift button 32 is pressed once, the maximum forward groundspeed may be increased by the predetermined increment. So, if the predetermined increment stored in the memory 38 is 0.5 mph, then the maximum forward groundspeed is reset to 4.5 mph and the groundspeed of the agricultural vehicle 12 (with the FNR lever 14 midway between the maximum forward and neutral positions) is 2.25 mph. If the downshift button 34 is then pressed, the groundspeed of the agricultural vehicle 12 returns to 2 mph. Furthermore, if the upshift button 32 is pressed twice in this example, the maximum forward groundspeed is reset to 5 mph, and the groundspeed of the agricultural vehicle 12, with the FNR lever 14 midway between the maximum forward and neutral positions is 2.5 mph.

In some embodiments of the invention, the FNR lever 14 may send a signal to the control system 18 or processor 35 corresponding to the FNR lever's position between the neutral position and the maximum forward or maximum rearward positions. Specifically, the ground speed (GS) may be equal to the maximum forward or maximum rearward speed (Smax) multiplied by a ratio of the FNR lever's position (LP). That is: GS=Smax×LP. For example, if the maximum forward speed is 10 mph and the FNR lever 14 is half way between the neutral position and the maximum forward position, then the control system 18 may plug these values into the equation above and solve for groundspeed, which would be 5 mph. That is: 10×0.5=5 mph. Then the control system 18 may command the vehicle actuation system 24 to operate at a ground speed of 5 mph.

To add the effects of the incremental control elements to the equation above, the maximum forward or maximum rearward speed (Smax) must be increased or decreased by a predetermined amount (A). That is GS=(Smax+A)×LP, where A is positive when the upshift button 32 is pressed and A is negative when the downshift button 34 is pressed. Alternatively, each time the upshift or downshift buttons 32, 34 are pressed, Smax may be updated to a new value resulting from Smax+A. Then the equation GS=Smax×LP may be used by the control system 18 as described above to determine a groundspeed command to send to the vehicle actuation system 24.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An agricultural vehicle comprising:
a frame;
a plurality of wheels attached to the frame;
a vehicle actuation system configured to actuate rotation of the wheels; and
a control system configured to send vehicle speed command signals to the vehicle actuation system of the agricultural vehicle for controlling groundspeed of the agricultural vehicle;
a forward-neutral-reverse (FNR) lever infinitely variable between a maximum forward position, a neutral position, and a maximum rearward position, wherein the FNR lever is configured to send a signal to the control system to actuate the agricultural vehicle at a maximum forward groundspeed when the FNR lever is at the maximum forward position and the FNR lever is configured to send a signal to the control system to actuate the agricultural vehicle at a maximum rearward groundspeed when the FNR lever is at the maximum rearward position;
an upshift button located on the FNR lever and configured to send a signal to the control system when pressed to increase the maximum forward groundspeed and/or the maximum rearward groundspeed by a predetermined amount; and
a downshift button located on the FNR lever and configured to send a signal to the control system when pressed to decrease the maximum forward groundspeed and/or the maximum rearward groundspeed by the predetermined amount,
wherein the control system is configured to scale vehicle speed command signals output to the vehicle actuation system relative to the maximum forward and/or maximum rearward groundspeeds indicated to the control system by the pressing of the upshift and downshift buttons.

2. The agricultural vehicle of claim 1, wherein the agricultural vehicle is a windrower.

3. The agricultural vehicle of claim 1, wherein the upshift and downshift buttons are located on a front side of the FNR lever relative to a direction of forward travel of the agricultural vehicle.

4. The agricultural vehicle of claim 1, wherein the control system comprises a processor and a user interface communicably coupled to the processor and configured for receiving an operator selection of the predetermined amount and sending the operator selection to the processor.

5. The agricultural vehicle of claim 1, wherein the control system comprises a processor and a display communicably coupled to the processor and configured to display information received from the processor.

6. The agricultural vehicle of claim 1, wherein the control system is configured to scale vehicle speed command signals output to the vehicle actuation system by adding or subtracting the predetermined amount to the maximum forward or maximum rearward groundspeed to calculate a new maximum forward or maximum rearward groundspeed, then multiplying the new maximum forward or maximum rearward groundspeed by a ratio or percentage corresponding to a position of the FNR lever between the neutral position and the maximum forward or maximum rearward position.

7. The agricultural vehicle of claim 6, wherein the control system adds the predetermined amount to the maximum forward or maximum rearward groundspeed if the upshift button is pressed and the control system subtracts the predetermined amount from the maximum forward or maximum rearward groundspeed if the downshift button is pressed.
